(19) United States
(12) Patent Application Publication
(10) Pub. No.: US 2003/0108764 A1
(43) Pub. Date: Jun. 12, 2003

(54) Method for improving bonding of circuit board substrates to metal surfaces and the articles formed thereby

(76) Inventors: John Thomas Neill, Woodstock, CT (US); Luis Daniel Borges, Pomfret Center, CT (US)

Correspondence Address: CANTOR COLBURN, LLP, 55 GRIFFIN ROAD SOUTH, BLOOMFIELD, CT, 06002

(21) Appl. No.: 10/006,989

(22) Filed: Dec. 4, 2001

(51) Int. Cl. B32B 31/26

(52) U.S. Cl. 428/618; 156/307.5

(57) ABSTRACT

A method for enhancing the adhesion between a metal surface and a circuit board substrate comprises contacting the metal surface with adhesion promoting solution comprising poly(vinyl butyral) having a molecular weight of about 70,000 to about 200,000 and a carrier; allowing the carrier to evaporate and forming an adhesion promoting layer; contacting the adhesion promoting layer with a curable thermosetting circuit board substrate composition; and curing the thermosetting composition. Use of an adhesion promoting layer comprising poly(vinyl butyral) having a molecular weight of about 70,000 to about 200,000 causes a large increase in both the tensile bond strength between the metal surface and thermoset resin and the uniformity of the tensile bond strength.

### BACKGROUND OF THE INVENTION

This disclosure relates to methods for improving the bond strength between a metal surface and a circuit board substrate, as well as the articles formed thereby.

Circuit board materials are well-known in the art, generally comprising a thermosetting substrate adhered to a conductive metal surface. In order to make electronic devices smaller, there is strong motivation to make circuit layouts as dense as possible. To that end, it is necessary to have circuit board materials with a low dielectric constant and a high glass transition temperature. However, when rigid thermosetting compositions with low dielectric constant and high glass transition temperature are used, the resulting circuit board material may have a low peel strength between the metal layer and the substrate. Peel strength may be even more severely reduced when low or very low profile copper foils are employed, such foils being critical to very dense circuit designs.

A number of efforts have been made to improve the bonding between the substrate material and the surface of the metal. U.S. Pat. No. 5,904,797 to Kwei discloses using chromium (III) methacrylate/polyvinyl alcohol solutions to improve bonding between thermoset resins and hydrophilic surfaces. The chromium methacrylate chemically bonds the thermoset resin to the hydrophilic surface. While chromium methacrylate is useful for some thermoset resins, it is not useful for all, notably polybutadiene and polyisoprene resins. PCT Application No. 96/19067 to McGrath discloses contacting the metal surface with an adhesion promoting composition comprising hydrogen peroxide, an inorganic acid, a corrosion inhibitor, and a quaternary ammonium surfactant. PCT Application No. 99/57949 to Holman discloses using an epoxy or phenoxy resin having a molecular weight greater than about 4500 to improve the peel strength of a laminate. There nonetheless remains a need in the art for methods for improving the bond between a metal surface and a circuit board substrate, particularly thermosetting substrates.

### SUMMARY OF THE INVENTION

A method for improving adhesion between a metal surface and a circuit board substrate comprises contacting a metal surface with an adhesion promoting solution comprising poly(vinyl butyral) having a molecular weight of about 70,000 to about 200,000 and a carrier, drying the adhesion promoting solution to form an adhesion promoting layer, contacting the adhesion promoting layer with a curable thermosetting composition, and curing the thermosetting composition. The adhesion promoting solution contains from about 2.5 weight percent (wt. %) to about 20 wt. % of poly(vinyl butyral) in a solvent, preferably acetone or an ethanol/toluene mixture.

In another embodiment, a circuit laminate is formed by adhering metal surface and a thermosetting circuit board substrate composition by a process comprising contacting a metal surface with an adhesion promoting solution comprising poly(vinyl butyral) having a molecular weight of about 70,000 to about 200,000 and a carrier, drying the adhesion promoting solution to form an adhesion promoting layer, contacting the adhesion promoting layer with a curable thermosetting composition, and curing the thermosetting composition.

The above-described method may be used in a variety of applications, but is particularly suited to the production of a circuit material with increased peel strength. The circuit material comprises a thermosetting composition adhered to a surface of a metal layer by an adhesion promoting layer comprising poly(vinyl butyral) with a molecular weight of about 70,000 to about 200,000, wherein both the thermosetting composition and the metal surface are in contact with the adhesion promoting layer.

The above-discussed and other features and advantages will be appreciated and understood by those skilled in the art from the following detailed description.

### BRIEF DESCRIPTION OF THE DRAWINGS

Referring now to the exemplary drawings.

FIG. 1 is a schematic representation of a circuit material; and

FIG. 2 is a schematic representation of a multilayer circuit material.

### DETAILED DESCRIPTION OF THE PREFERRED EMBODIMENTS

A method for enhancing the adhesion between a metal surface and the surface of a circuit board substrate comprises use of an adhesion promoting solution comprising poly(vinyl butyral) having a molecular weight of about 70,000 to about 200,000. This adhesion promoting layer causes a large increase in both the tensile bond strength between the metal surface and thermoset resin and the uniformity of the tensile bond strength.

Poly(vinyl butyral) (PVB) is commercially available. Useful poly(vinyl butyral) has a molecular weight of about 70,000 to about 200,000, with a molecular weight of about 70,000 to about 90,000 preferred. The adhesion promoting solution preferably contains about 2.5 wt. % to about 20 wt. % poly(vinyl butyral) based on the total weight of the solution in a carrier.

Suitable carriers include solvents capable of dissolving poly(vinyl butyral) including, but not limited to, ethanol, ethanol/toluene mixtures, acetone, methyl isobutyl ketone, and mixtures comprising at least one of the foregoing carriers. Another suitable carrier is water. Aqueous dispersions of poly(vinyl butyral) may also be used, such as the dispersion of poly(vinyl butyral) in water available from Solutia, Springfield, Mass. under the trade name BUTVAR BR.

The adhesion promoting solution may optionally include cross-linking agents and fillers. Suitable cross-linking agents are present in amounts of about 0.1 to about 10 wt. % of the total composition, and include those useful with poly(vinyl butyral) such as phenolics, epoxides, dialdehydes, isocyanates, and melamines. Useful fillers include organic and inorganic fillers in both particulate and fibrous forms, and are present in amounts of about 0 to about 20 wt. % based on the total weight of the composition. Inorganic fillers such as silica microspheres are preferred.

Wetting agents may also be added to improve substrate wetting during coating in amounts of about 0.5 to about 4.0 wt. % of the total composition. Wetting agents are well known in the art and are commercially available. One such useful wetting agent is available from Solutia of Springfield, Mass. under the tradename Modaflow A-Q 3000.

Defoamers in amounts of about 0.05 to about 1 wt % of the total composition can be added to reduce foaming during application, especially during spray coating. Defoamers are commercially available and one such useful defoamer is available from Dow Corning of Midland Mich. under the tradename Dow Corning 7 Additive.

Metal surfaces suitable for use herein include surfaces provided by one or more conductive metal foils such as foils of copper, aluminum, zinc, iron, transition metals and their alloys. Copper foil is preferred. There are no particular limitations regarding the thickness of the metal foil nor as to the shape, size, or texture of the surface. Additionally, the metal surface may be used as obtained from the supplier or subsequent to a cleaning procedure such as burnishing.

Suitable circuit board substrates are thermosetting compositions employ resins that cure by a free radical process. Such resins include rubber, polyester, vinyl, acrylic, polybutadiene, polyisoprene, polybutadiene and polyisoprene copolymers, polyurethane resins and combinations comprising one of the foregoing resins. Compositions containing polybutadiene, polyisoprene, and/or polybutadiene and polyisoprene copolymers are especially preferred. The thermosetting compositions may also include particulate fillers, elastomers, flame retardants, and other components known in the art.

In general, the preferred thermosetting compositions are processed as described in U.S. Pat. No. 5,571,609 to St. Lawrence et al. The thermosetting composition generally comprises: (1) a polybutadiene or polyisoprene resin or mixture thereof; (2) an optional functionalized liquid polybutadiene or polyisoprene resin; (3) an optional butadiene- or isoprene-containing polymer capable of participating in crosslinking with the polybutadiene or polyisoprene resin during cure; and (4) an optional low molecular weight polymer such as ethylene propylene rubber or ethylene-propylene-diene monomer elastomer.

The polybutadiene or polyisoprene resins may be liquid or solid at room temperature. Liquid resins may have a molecular weight greater than 5,000, but preferably have a molecular weight of less than 5,000 (most preferably between 1,000 or 3,000). The preferably liquid (at room temperature) resin portion maintains the viscosity of the composition at a manageable level during processing to facilitate handling, and it also crosslinks during cure. Polybutadiene and polyisoprene resins having at least 90% 1,2-addition by weight are preferred because they exhibit the greatest crosslink density upon cure owing to the large number of pendant vinyl groups available for crosslinking. High crosslink densities are desirable because the products exhibit superior performance in an electrochemical cell environment at elevated temperatures. A preferred resin is B3000 resin, a low molecular weight polybutadiene liquid resin having greater than 90 weight percent (wt. %) 1,2-addition. B3000 resin is commercially available from Nippon Soda Co., Ltd.

The thermosetting composition optionally comprises functionalized liquid polybutadiene or polyisoprene resins. Examples of appropriate functionalities for butadiene liquid resins include but are not limited to epoxy, maleate, hydroxy, carboxyl and methacrylate. Examples of useful liquid butadiene copolymers are butadiene-co-styrene and butadiene-co-acrylonitrile. Possible functionalized liquid polybutadiene resins include Nisso G-1000, G-2000, G-3000; Nisso C-1000; Nisso BN-1010, BN-2010, BN-3010, CN-1010; Nisso TE-2000; and Nisso BF-1000 commercially available from Nippon Soda Co., Ltd. and Ricon 131/MA commercially available from Colorado Chemical Specialties, Inc.

The optional, butadiene- or isoprene-containing polymer may be unsaturated and can be liquid or solid. It is preferably a solid, thermoplastic elastomer comprising a linear or graft-type block copolymer having a polybutadiene or polyisoprene block, and a thermoplastic block that preferably is styrene or α-methyl styrene. Possible block copolymers, e.g., styrene-butadiene-styrene tri-block copolymers, include Vector 8508M (commercially available from Dexco Polymers, Houston, Tex.), Sol-T-6302 (commercially available from Enichem Elastomers American, Houston, Tex.), and Finaprene 401 (commercially available from Fina Oil and Chemical Company, Dallas, Tex.). Preferably, the copolymer is a styrene-butadiene di-block copolymer, such as Kraton D1118X (commercially available from Shell Chemical Corporation). Kraton D1118X is a di-block styrene-butadiene copolymer containing 30 vol % styrene.

The unsaturated butadiene- or isoprene-containing polymer may also contain a second block copolymer similar to the first except that the polybutadiene or polyisoprene block is hydrogenated, thereby forming a polyethylene block (in the case of polybutadiene) or an ethylene-propylene copolymer (in the case of polyisoprene). When used in conjunction with the first copolymer, materials with enhanced toughness can be produced. Where it is desired to use this second block copolymer, a preferred material is Kraton GX1855 (commercially available from Shell Chemical Corp.), which is believed to be a mixture of styrene-high 1,2 butadiene-styrene block copolymer and styrene-(ethylene-propylene)-styrene block copolymer.

Thus, in a preferred embodiment, the butadiene- or isoprene-containing polymer comprises a solid thermoplastic elastomer block copolymer having the formula Xₘ(Y-X)ₙ (linear copolymer) or

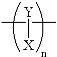

(graft copolymer), where Y is a polybutadiene or polyisoprene block, X is a thermoplastic block, and m and n represent the average block numbers in the copolymer, m is 0 or 1 and n is at least 1. The composition may further include a second thermoplastic elastomer block copolymer having the formula Wₚ-(Z-W)_{q} (linear copolymer) or

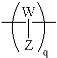

(graft copolymer) where Z is a polyethylene or ethylene-propylene copolymer block, W is a thermoplastic block, and p and q represent the average block numbers in the copolymer, p being 0 and 1 and q being at least 1.

The volume to volume ratio of the polybutadiene or polyisoprene resin to butadiene- or isoprene-containing polymer preferably is between 1:9 and 9:1, inclusive. The selection of the butadiene- or isoprene-containing polymer depends on chemical and hydrolysis resistance as well as the toughness conferred upon the molded material.

The optional low molecular weight polymer resin is generally employed to enhance toughness and other desired characteristics of composition. Examples of suitable low molecular weight polymer resins include, but are not limited to, telechelic polymers such as polystyrene, multifunctional acrylate monomers, EPR or EPDM containing varying amounts of pendant norbornene groups and/or unsaturated functional groups. The optional low molecular weight polymer resin can be present in amounts of about 0 to about 30 wt % of the resin composition.

Monomers with vinyl unsaturation may also be included in the resin system for specific property or processing conditions, such as to decrease the viscosity of the conductive moldable composite material, especially with high filler loading. Viscosity is a key factor in obtaining acceptable molding rheologies. Inclusion of one or more monomers with vinyl unsaturation has the added benefit of increasing crosslink density upon cure. Suitable monomers must be capable of co-reacting with one of the other resin system components. Examples of suitable monomers include styrene, vinyl toluene, divinyl benzene, triallylcyanurate, diallylphthalate, and multifunctional acrylate monomers (such as Sartomer compounds available from Arco Specialty Chemicals Co.), among others, all of which are commercially available. The useful amount of monomers with vinyl unsaturation is about 0% by weight to about 80% by weight of the resin composition and preferably about 3% to about 50%.

A curing agent is preferably added to the resin system to accelerate the curing reaction. When the composition is heated, the curing agent decomposes to form free radicals, which then initiate cross linking of the polymeric chains. Preferred curing agents are organic peroxides such as Luperox, dicumyl peroxide, t-butyl perbenzoate, 2,5-dimethyl-2,5-di(t-butyl peroxy)hexane, αα′-bis(t-butyl peroxy)diisopropylbenzene, and 2,5-dimethyl-2,5-di(t-butyl peroxy) hexyne-3, all of which are commercially available. They may be used alone or in combination. Typical amounts of curing agent are from about 1.5 part per hundred parts of the total resin composition (PHR) to about 6 PHR.

The adhesion promoting solution is prepared by adding the desired amounts of poly(vinyl butyral) and other optional ingredients to the carrier and mixing thoroughly. In a preferred embodiment, this composition is applied to the metal surface, for instance a copper surface, by dip-, spray-, wash- or other coating technique to provide a weight pick up of the composition on the copper foil after drying of about 1 to about 20 grams per square meter (g/m²) and preferably from about 5 to about 12 g/m².

The carrier is allowed to evaporate under ambient conditions or by forced or heated air, and the thermosetting composition is applied to the dried adhesion promoting layer surface. The thermosetting composition is cured and the laminated material is formed by an effective quantity of temperature and pressure, which will depend upon the particular thermosetting composition. Alternatively, the thermosetting composition can be cured by other methods well known to those skilled in the art such as microwave, electron beam, and catalytic methods and then laminated with the coated metal surface using heat and pressure.

Use of the adhesion promoting layer as described above resulted in an increased peel strength of the bilayer of about 2 pounds per linear inch (pli) to about 6 pli, an improvement of 50%. Additionally no undercut was observed in laminate materials prepared with the adhesion promoting layer after exposure to a sulfuric acid solution (undercut is penetration or attack along the metal-polymer bond line which leads to bond strength reduction). Laminate material prepared without the adhesion promoting layer showed a 4.5 mil undercut.

Accordingly, the above-described method may be used to produce a circuit material with increased peel strength. The circuit material comprises a thermosetting composition adhered to a surface of a metal layer by an adhesion promoting layer comprising poly(vinyl butyral) having a molecular weight of about 70,000 to about 200,000, wherein both the thermosetting composition and the metal surface are in contact with the adhesion promoting layer.

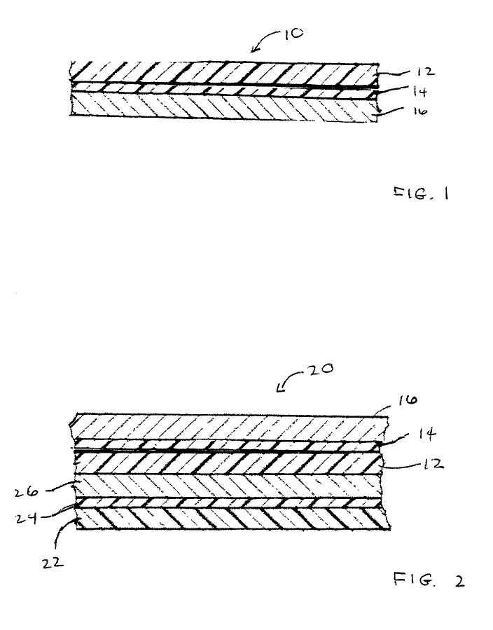

FIG. 1 is a schematic representation of an exemplary circuit material 10. Circuit material 10 comprises a thermosetting composition 12 disposed adjacent to adhesion promoting layer 14 which, in turn, is disposed adjacent to a hydrophilic surface of a conductive layer 16. Preferably the metal layer is copper. The thermosetting composition preferably comprises polybutadiene, polyisoprene, polybutadiene copolymer, polyisoprene copolymer or combination comprising one of the foregoing resins. The circuit material has excellent bond strength as discussed above.

FIG. 2 is a schematic representation of a multilayer circuit material. A circuit material comprising a dielectric thermosetting composition 12, adhesion promoting layer 14 and conductive metal layer 16 is itself laminated adjacent a second circuit comprising second dielectric layer 22, second adhesion promoting layer 24 and second conductive metal layer 26. The circuits may be flexible or stiff.

The invention is further illustrated by the following non-limiting Examples.

### EXAMPLES

### Examples 1-4

Example 1 is a control. Examples 2-4 use 10 wt. % of poly(vinyl butyral) in the carrier listed on the table. The varying grades of poly(vinyl butyral) are available from Solutia located in Springfield, Mass. The poly(vinyl butyral) solution was applied to ½-oz. TWX copper foil available from Yates Foil of Bordentown, N.J., using knife-over-plate metering with a 15 mil foil-blade setting. The foil was dried and weight uptake of the poly(vinyl butyral) on foil was in the range of 860-1172 mg/100 square inches. An RO4350B prepreg (a polybutadiene-based thermosetting composition available from Rogers Corp., Rogers, Conn.) was then applied. Lamination temperature was 246° C. Peel strength is shown in Table 1. Peel strength was tested in accordance with IPC-TM-650.

TABLE 1

| No. | Foil treatment | Carrier | Peel Strength, pli |
|---|---|---|---|
| 1* | None | — | 4.8 |
| 2 | Butvar B-76 | Acetone | 8.2 |
| 3 | Butvar B-79 | Acetone | 8.0 |
| 4 | Butvar B-90 | Acetone/ethanol | 7.9 |

*Control

Table 1 shows that peel strength is significantly increased to 7.9-8.2 pli from 4.8 pli by treating the copper foil with poly(vinyl butyral).

### Examples 5-7

Samples 5-7 were prepared as in examples 1-4 using varying grades of poly(vinyl butyral) from Solutia of Springfield, Mass. in a 10 wt. % solution with ethyl alcohol as the carrier. The samples were dried and tested for peel strength before and after immersion for 24 hours in water. Results are shown in Table 2.

TABLE 2

| | | Peel Strength Before | Peel Strength After |
|---|---|---|---|
| No. | PVB Grade | Immersion, pli | Immersion, pli |
| 5* | Butvar B-76 | 9.6 | 9.0 |
| 6 | Butvar B-79 | 9.7 | 8.7 |
| 7 | Butvar B-90 | 9.3 | 8.4 |

*Control
**Coated twice

Table 2 shows that the copper bond using the adhesion promoting layer is highly tolerant to moisture.

Although the copper-clad laminates described in the examples were prepared by applying the adhesion promoting layer to the copper foil prior to lamination, the adhesion promoting layer may be applied to the thermosetting composition prior to lamination of the thermosetting composition to the copper foil. It is also specifically envisioned that copper foils can be pre-treated with the adhesion promoting layer and stored until needed for lamination.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method for improving adhesion between a metal surface and a circuit board substrate, comprising:
contacting the metal surface with an adhesion promoting solution comprising poly(vinyl butyral) having a molecular weight of about 70,000 to about 200,000 and a carrier;
drying the adhesion promoting solution to form an adhesion promoting layer;
contacting the adhesion promoting layer with a curable thermosetting circuit board substrate composition; and
curing the thermosetting composition.

2. The method of claim 1, wherein the adhesion promoting composition comprises about 2.5 wt. % to about 20 wt. % of poly(vinyl butyral).

3. The method of claim 1, wherein the poly(vinyl butyral) has a molecular weight of about 70,000 to about 90,000.

4. The method of claim 1, wherein the adhesion promoting solution further comprises a cross-linking agent, a filler, a wetting agent, a defoamer, or a combination comprising at least of one of the foregoing.

5. The method of claim 1, wherein the metal surface is selected from the group consisting of copper, aluminum, zinc, iron, transition metals, and their alloys.

6. The method of claim 1 wherein curing is by free radical.

7. The process of claim 6 wherein the thermosetting composition comprises polybutadiene, polyisoprene, polybutadiene copolymer, polyisoprene copolymer or a combination comprising one of the foregoing resins.

8. The method of claim 6 wherein the thermosetting composition further comprises a filler.

9. The method of claim 1, wherein the carrier is selected from the group consisting of ethanol, ethanol/toluene mixtures, methyl isobutyl ketone, and mixtures comprising as least one of the foregoing.

10. The method of claim 1, wherein the carrier is water.

11. A method for improving adhesion between a copper surface and a circuit board substrate comprising:
contacting the copper surface with an adhesion promoting solution comprising poly(vinyl butyral) having a molecular weight of about 70,000 to about 200,000 and a carrier with the copper surface;
drying the adhesion promoting solution to form an adhesion promoting layer;
contacting a thermosetting circuit board substrate composition comprising polybutadiene, polyisoprene, polybutadiene copolymer, polyisoprene copolymer or combination comprising one of the foregoing resins with the adhesion promoting layer; and
curing the thermosetting composition.

12. A circuit material produced by the method comprising:
contacting a copper foil surface with an adhesion promoting solution comprising poly(vinyl butyral) having a molecular weight of about 70,000 to about 200,000 and a carrier;
drying the adhesion promoting solution to form an adhesion promoting layer;
contacting a thermosetting circuit board substrate composition with the adhesion promoting layer; and
curing the thermosetting composition.

13. The circuit material of claim 12, wherein the adhesion promoting solution comprises about 2.5 wt. % to about 20 wt. % of poly(vinyl butyral).

14. The circuit material of claim 12, wherein the poly(vinyl butyral) has a molecular weight of about 70,000 to about 90,000.

15. The circuit material of claim 12, wherein the adhesion promoting solution further comprises a cross-linking agent, a filler, a wetting agent, a defoamer 1 or a combination comprising at least one of the foregoing.

16. The circuit material of claim 12, wherein the thermosetting circuit substrate composition cures by free radical process.

17. The circuit material of claim 12, wherein the thermosetting circuit substrate composition comprises polybutadiene, polyisoprene, polybutadiene copolymer, polyisoprene copolymer or a combination comprising one of the foregoing resins.

18. The circuit material of claim 12, wherein the thermosetting circuit substrate composition further comprises a filler.

19. A circuit material comprising:
a thermosetting circuit substrate layer;
a copper layer; and
an adhesion promoting layer disposed between at least a portion of the thermosetting polymer layer and at least a portion of the surface of the copper layer, wherein the adhesion promoting layer comprises poly(vinyl butyral) having a molecular weight of about 70,000 to about 200,000.
